(19) United States
(12) Patent Application Publication
(10) Pub. No.: US 2011/0053800 A1
(43) Pub. Date: Mar. 3, 2011

(54) METHOD OF MANUFACTURING PATTERNED SUBTRATE FOR CULTURING CELLS, PATTERNED SUBTRATE FOR CULTURING CELLS, PATTERNING METHOD OF CULTURING CELLS, AND PATTERNED CELL CHIP

(75) Inventors: Dong Geun Jung, Seoul (KR); Chang Rok Choi, Gyeonggi-do (KR); Kyung Seop Kim, Incheon (KR)

(73) Assignee: SUNGKYUNKWAN UNIVERSITY Foundation for Corporate Collaboration, Gyeonggi-do (KR)

(21) Appl. No.: 12/872,903

(22) Filed: Aug. 31, 2010

(30) Foreign Application Priority Data
Sep. 1, 2009 (KR) 10-2009-0082152

(51) Int. Cl. C40B 40/02; B05D 5/00; C40B 60/14; C40B 50/06

(52) U.S. Cl. 506/14; 427/2.11; 506/40; 506/26

(57) ABSTRACT

The present invention relates to a method of manufacturing a patterned substrate for culturing cells, comprising the steps of: (1) preparing a substrate; (2) forming a first plasma polymer layer by integrating a first precursor material using a plasma on the substrate; (3) placing a shadow mask having a predetermined pattern on the first plasma polymer layer; and (4) forming a second patterned plasma polymer layer by integrating a second precursor material using a plasma.

### BACKGROUND OF THE INVENTION

1. Field of the Invention

The present invention relates to a method of manufacturing a patterned substrate for culturing cells, a patterned substrate for culturing cells, a patterning method for culturing cells, and a cell chip; and more particularly, a method of manufacturing a patterned substrate for culturing cells, a patterned substrate for culturing cells, a patterning method for culturing cells, and a cell chip, in which a substrate capable of inhibiting cell adsorption is manufactured using a plasma and cells are selectively cultured by patterning and integrating many numbers of functional groups on the substrate.

2. Description of the Related Art

Research relating to human life such as the human genome project is rapidly increasing. Information analysis and understanding of the operation of living organisms are gathering strength with ongoing research on living organisms. Accordingly, interest in biochips for rapid analysis of information on organisms has dramatically increased recently more than ever before.

Biochips can be divided into DNA chips, protein chips and cell chips according to a biomaterial which is fixed or cultured on a substrate. In the beginning of the biochip era, DNA chips appeared to be a key in understanding human genetic information, but protein chips and cell chips have been recently become attractive as representatives biochips, with the increased interest in proteins and cells in which a protein binds. Even though non-specificity in binding has been an important problem associated with protein chips, a variety of notable methods are now being introduced.

Among them, a cell chip which is capable of culturing a large amount of cells without affecting their properties is appearing to be the most effective tool to access various fields including novel drug development, genomics, and proteomics, etc. A cell chip is different from a protein chip in that the rate of cell growth on a substrate in the cell chip is one of indications representing the performance of the cell chip. Meanwhile, when the growth and division of cells cultured on a substrate is observed, the behavior of the cells can be easily analyzed. For example, the effect of cells to a new drug or the response of cells to materials in vivo such as hormones, can be easily examined.

Various methods for culturing cells on a substrate have been developed, and can be broadly divided by a method using a biomaterial and a method using physical and chemical characteristics of the substrate itself. In the method using a biomaterial, peptides or proteins are first fixed on a substrate, and cells are cultured using cell receptors contained in their biomaterials [Mann B K, Tsai A T, Scott-Burden T, West J L. Modification of surfaces with cell adhesion peptides alters extracellular matrix deposition. Biomaterials 1999; 20(23-24):2281-6].

Examples of the method using physical and chemical characteristics of a substrate include a method using hydrophobic characteristics, a method using electrical characteristics, a method using surface characteristics [Curtis A S, Wilkinson C D. Reactions of cells to topography. J Biomater SciPolym Ed 1998; 9(12):1313-29], a method using collagen [On-chip transfection of PC12 cells based on the rational understanding of the role of ECM molecules: efficient, non-viral transfection of PC12 cells using collagen IV, Neuroscience Letters 378 (2005) 40-43], etc.

There are several drawbacks associated with cell chips of which the most general one is that cells are not cultured well on a substrate. When cells are cultured evenly without conglomeration on a substrate, the cells can grow or divide on the substrate. On the other hand, when cells are not cultured properly on the substrate, the cells fail to grow and divide. Further, successful cell culture means that a small amount of cells are exactly cultured. A small amount of cells must be exactly cultured on a substrate, which can eventually increase the sensitivity of the cell chip.

Second, when cells are cultured on the substrate, their intrinsic properties or organization have to be well maintained. If the cells fail to grow or the cells' characteristics are lost due to the substrate even though the cells are well cultured on the substrate, the cell chip cannot perform its function fully. Therefore, it is necessary to consider the above factors in the development of cell chips.

To solve the above problems, a method of efficiently and effectively performing cell culture using a plasma disclosed in PCT/KR2008/001117. This application discloses a method of manufacturing a substrate for fixing cells, a substrate for fixing cells, a method of fixing cells and a cell chip. This application mentions a method of a substrate for fixing cells, a substrate for fixing cells, a method of fixing cells and a cell chip, which is able to fix cells efficiently by integrating many numbers of functional groups on a substrate using a plasma. However, this application mentions only the method of fixing cells on a substrate using a plasma or the like, but does not mention a method of selectively culturing cells by cell adsorption and inhibition of cell adsorption.

When the substrate is patterned to have a surface for inhibition of cell adsorption and a surface for effective cell culture, it can be applicable in the development of implantable chips and artificial organs, genetic experiments, and drug tests. However, the application discloses only the method of uniformly culturing cells, and thus it is impossible to selectively culture a small amount of cells in a desired position.

Therefore, the present inventors have studied and invented a method of manufacturing a patterned substrate for culturing cells, which is capable of selectively culturing cells in the desired position of the substrate using a plasma.

### SUMMARY OF THE INVENTION

To solve the above described problems, it is an object of the present invention to provide a method of manufacturing a patterned substrate for culturing cells, which is capable of selectively patterning the surface for effective cell culture on the surface inhibiting cell adsorption.

It is another object of the present invention to provide a patterned substrate for culturing cells, which is manufactured by the above method of manufacturing a patterned substrate for culturing cells.

It is still another object of the present invention to provide a patterning method for culturing cells, which is capable of selectively culturing a small amount of cells in the desired position using the patterned substrate for culturing cells.

It is still another object of the present invention to provide a cell chip manufactured by the patterning method for culturing cells, which is applicable in the development of artificial organs, implantable chips, and novel drugs, genomics, and proteomics.

### BRIEF DESCRIPTION OF THE DRAWINGS

FIG. 1 is a schematic view of a plasma enhanced chemical vapor deposition apparatus 10 to form a first plasma polymer layer on a substrate;

FIG. 2 is a schematic view of an inductively coupled plasma enhanced chemical vapor deposition apparatus 100 to manufacture the patterned substrate for culturing cells according to the present invention;

FIG. 3 is a schematic diagram showing the method of manufacturing a patterned substrate for culturing cells according to the present invention;

FIG. 4(a) is a schematic view of a shadow mask having a predetermined pattern, and FIG. 4(b) is a plane view of the patterned substrate for culturing cells according to the present invention;

FIG. 5 is a schematic diagram showing another method of manufacturing a patterned substrate for culturing cells according to the present invention;

FIG. 6 shows photographs of rat intestinal epithelial cells, which were cultured for 24 hrs on the substrates having a first plasma polymer layer manufactured by various methods; and

FIG. 7 shows photographs of rat intestinal epithelial cells, which were cultured for 2 hrs, 8 hrs, and 24 hrs on the patterned substrate for culturing cells according to the present invention.

### DESCRIPTION OF THE PREFERRED EMBODIMENTS

To achieve the above objects, an aspect of the present invention provides a method of manufacturing a patterned substrate for culturing cells, comprising the steps of: (1) preparing a substrate; (2) forming a first plasma polymer layer by integrating a first precursor material using a plasma on the substrate; (3) placing a shadow mask having a predetermined pattern on the first plasma polymer layer; and (4) forming a second patterned plasma polymer layer by integrating a second precursor material using a plasma.

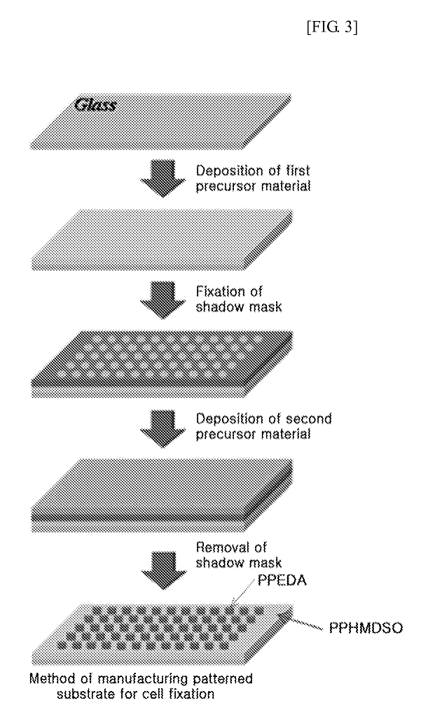

FIG. 3 is a schematic diagram showing the method of manufacturing a patterned substrate for culturing cells according to the present invention. With reference to FIG. 3, the above steps will be described in detail.

(1) Preparation of Substrate

As used herein, the term “substrate” means all types of plates on which a precursor material can be integrated using a plasma and, in particular, may be selected from the group consisting of glass, plastic, metal and silicone. However, the type of substrate is not particularly limited, as long as the precursor material can be integrated thereon using a plasma. Preferably, a glass slide is prepared as a substrate.

(2) Formation of First Plasma Polymer Layer by Integration of First Precursor Material on Substrate Using Plasma

As used herein, the term “plasma” refers to an electrically neutral gas, into which electric energy or heat energy is provided to allow electrons and ions to coexist. Technologies using the plasma have been greatly developed and its use is more and more active in various fields including plasma etching and plasma enhanced chemical vapor deposition (PECVD) in the semiconductor manufacturing process, the surface treatment of metals or polymers, synthesis of new materials such as synthetic diamonds, plasma display panels (PDP) and environmental technologies

As used herein, the term “precursor material” means a preceding material capable of forming a plasma polymer layer using a plasma.

The first precursor material of the present invention is not particularly limited, as long as it is able to inhibit cell adsorption. The preferred first precursor material may include siloxane-based compounds, such as hexamethyldisiloxane, octamethyltrisiloxane, decamethyltetrasiloxane, hexa methylcyclotrisiloxane, octamethyl cyclotetrasiloxane, and decamethylcyclopentasiloxane. Non-siloxane-based compounds such as styrene and n-hexane may be used as the first precursor material. Most preferably, the first precursor material is a siloxane-based compound, in which the siloxane-based compound is hexamethyldisiloxane.

The reason is that the plasma polymer layer formed of the above materials inhibits the binding between the substrate and cells, and thus it is excellent in term of inhibition of cell adsorption.

As used herein, the term “integration” means the degradation of the precursor material using plasma energy and formation of a plasma polymer layer by the degraded by-products.

The first plasma polymer layer may be formed by a plasma enhanced chemical vapor deposition method.

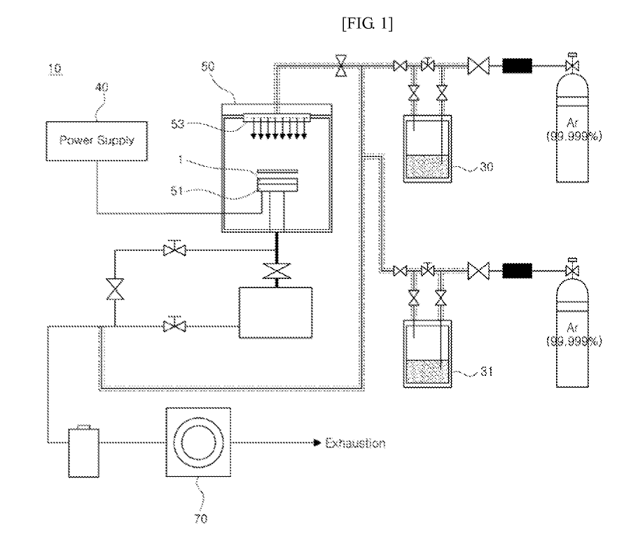

The plasma enhanced chemical vapor deposition apparatus used to perform step (2) will be described in detail with reference to FIG. 1. FIG. 1 is a schematic view of a plasma enhanced chemical vapor deposition apparatus 10 to form the first plasma polymer layer on a substrate.

With reference to FIG. 1, the constitution of the plasma enhanced chemical vapor deposition apparatus 10 will be described in detail. The apparatus includes a plasma reaction chamber 50 where plasma is formed, a vacuum part including a vacuum pump 70 to control the inner pressure of the plasma reaction chamber 50, a gas injection part including a bubbler 30, 31 to inject the first precursor material in the gas state into the plasma reaction chamber 50, and a power supply device 40 to supply a voltage to an internal electrode (SB) or a bottom electrode arranged inside the plasma reaction chamber 50. A substrate holder 51 and the internal electrode (SB) to support the substrate holder 51 by being arranged at the lower part of the substrate holder 51 are sequentially installed inside the plasma reaction chamber 50.

The step of forming a first plasma polymer layer by integrating a first precursor material on the substrate using the plasma enhanced chemical vapor deposition apparatus 10 will be described in detail.

First, a substrate 1 is installed on the substrate holder 51 inside the plasma reaction chamber 50. Subsequently, the pressure inside the plasma reaction chamber 50 is lowered to several mili torr (mtorr), which is closer to the vacuum state, by using the vacuum pump 70, and a first precursor material is then injected along with a carrier gas through the gas injection part into the plasma reaction chamber 50. Here, when a voltage is supplied to the internal electrode (SB) using the power supply device, the plasmas generated by the internal electrode (SB) are formed between the substrate 1 and the outer wall of the plasma reaction chamber 50. At this time, while the first precursor material is polymerized by the generated plasma, the first plasma polymer layer is deposited uniformly on the substrate 1.

In this connection, either the external electrode or the internal electrode may be used, but when the internal electrode is only used, it is more efficient and effective for the deposition of the first plasma polymer layer. In addition, the power of the power supply device of the plasma reaction chamber 50 applied to the internal electrode (SB) is preferably 10 W.

Further, before the first precursor material is injected into the plasma reaction chamber 50, it is preferable to vaporize the first precursor material. The first precursor material may be vaporized by heating it using the bubbler 30, 31 and the vaporization temperature is preferably 50° C. to 116° C. Most preferably, the first precursor material is vaporized at the temperature of 30° C. to 70° C., and plasma-deposited.

The first precursor material may be preferably injected along with a carrier gas into the plasma reaction chamber 50. The carrier gas to be used may be Ar, N₂, He or H₂, and more preferably Ar. A flow rate of the carrier gas into the plasma reaction chamber 50 is preferably 10 to 50 sccm, and more preferably 15 sccm.

The temperature of the substrate 1 inside the plasma reaction chamber 50 is preferably room temperature, and pressure inside the plasma reaction chamber 50 may be 10 mTorr to several torr, and preferably 500 mTorr.

(3) Placement of Shadow Mask Having Predetermined Pattern on First Plasma Polymer Layer

As used herein, the term “shadow mask” means a thin metal plate with tiny holes that allows the exposing of a desired specific region. The material and shape of the shadow mask are not particularly limited, as long as it is placed on the first plasma polymer layer and forms the second plasma polymer layer in a predetermined pattern in Step (4) as described below.

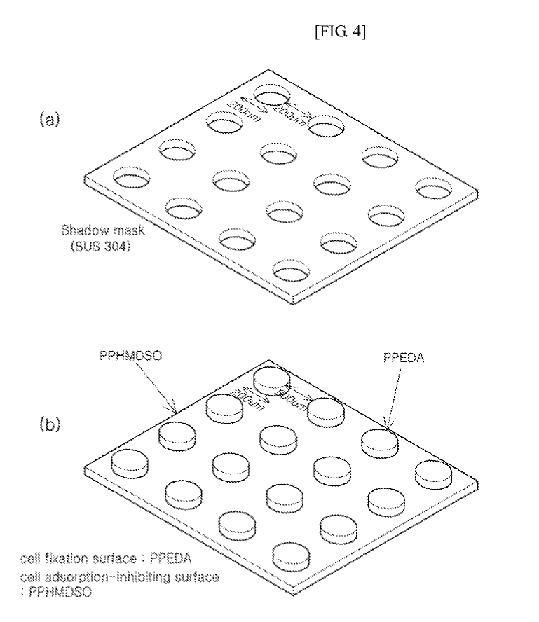

FIG. 4(a) is a schematic view of a shadow mask having a predetermined pattern. With reference to FIG. 4(a), in the shadow mask of the present invention, the predetermined pattern is provided with a plurality of holes having a diameter of 200 μm, and the space between the holes is 200 μm. The material is Stainless Steel 304. However, it is apparent that the material and shape of the shadow mask can be changed by a user.

(4) Formation of a Second Plasma Polymer Layer by Integrating a Second Precursor Material Using Plasma

The second precursor material of the present invention is not particularly limited, as long as it is able to culture cells on the substrate without cell modification. However, the precursor material of the present invention may be any precursor material having various types of function groups, such as an amine group, an aldehyde group, a carboxyl group, and a thiol group, and is preferably a precursor material having an amine group. Moreover, the second precursor material may be preferably ethylenediamine, acetonitrile, allylamine propylamine, cycloheptane, cyclohexane, cyclopentane or the like, and most preferably ethylenediamine.

The reason is that the plasma polymer layer formed of the above materials is able to culture cells on the substrate without cell modification, and thus it is excellent in term of improvement of cell culture.

Preferably, the second plasma polymer layer may be formed by inductively coupled plasma enhanced chemical vapor deposition.

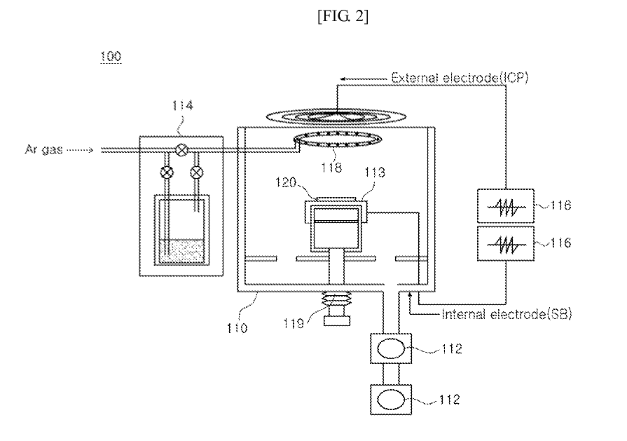

The inductively coupled plasma enhanced chemical vapor deposition apparatus 100 used to perform step (4) will be described in detail with reference to FIG. 2. FIG. 2 is a schematic view of inductively coupled plasma enhanced chemical vapor deposition apparatus 100 to manufacture the patterned substrate for culturing cells according to the present invention.

With reference to FIG. 2, the constitution of the inductively coupled plasma enhanced chemical vapor deposition apparatus 100 will be described in detail. The apparatus includes a reaction chamber 110 where plasma is formed, a vacuum part including a vacuum pump 112 to control inner pressure of the plasma reaction chamber 110, a gas injection part including a bubbler 114 to inject the second precursor material in the gas state into the plasma reaction chamber 110, and a power supply device to supply a voltage to an external electrode (ICP; Inductively Coupled Plasma) arranged on the upper part of the plasma reaction chamber 110 and an internal electrode (SB; Substrate bias) arranged inside the plasma reaction chamber 110. A substrate holder 113 and the internal electrode (SB) to support the substrate holder 113 by being arranged at the lower part of the substrate holder 113 are sequentially installed inside the plasma reaction chamber 110.

Meanwhile, the external electrode (ICP) and the internal electrode (SB) may be any electrode which can be used for a general plasma enhanced chemical vapor deposition apparatus, regardless of material and shape. In particular, the shape of the external electrode (ICP) is preferably a flat circular coil, and the material of the internal electrode (SB) is preferably a material which does not have chemical reactions and be environmental friendly, and more preferably a material made of stainless.

The step of forming a second plasma polymer layer using the inductively coupled plasma enhanced chemical vapor deposition apparatus 100 will be described in detail.

A substrate 120, on which the first plasma polymer layer is formed, is installed on the substrate holder 113 inside the plasma reaction chamber 110. The shadow mask having a predetermined pattern is fixed on the substrate 120, on which the first plasma polymer layer is formed. Subsequently, the pressure inside the plasma reaction chamber 110 is lowered to several mili torr (mtorr), which is closer to the vacuum state, by using the vacuum pump 112, and a second precursor material is then injected along with a carrier gas through the gas injection part into the plasma reaction chamber 110. Here, when a voltage is supplied to the external electrode (ICP) and the internal electrode (SB) using the power supply device, the plasmas generated by the external electrode (ICP) and the internal electrode (SB) are formed between the substrate 120 having the first plasma polymer layer and the outer wall of the plasma reaction chamber 110. At this time, while the second precursor material having a functional group is polymerized by the generated plasma, a second plasma polymer layer is deposited selectively on the substrate 120 having the first plasma polymer layer.

In this connection, either the external electrode or the internal electrode may be used. However, when both electrodes are used, it is more efficient and effective for the deposition of the patterned substrate for culturing cells. In addition, the power of the power supply device of the plasma reaction chamber 110 applied to the external electrode (ICP) may be preferably 3 W, 30 W or 70 W, and more preferably 3 W. The power applied to the internal electrode (SB) may be preferably 3 W to 50 W, and more preferably 3 W.

Further, before the second precursor material is injected into the plasma reaction chamber 110, it is preferable to vaporize the second precursor material. The second precursor material may be vaporized by heating it using the bubbler 114 and the vaporization temperature is preferably 50° C. to 116° C. Most preferably, the second precursor material is vaporized at the temperature of 30° C. to 70° C., and plasma-deposited.

Further, the second precursor material may be preferably injected along with a carrier gas into the plasma reaction chamber 110. The carrier gas to be used may be Ar, N₂, He or H₂, and more preferably Ar. A flow rate of the carrier gas into the plasma reaction chamber 110 is preferably 10 to 50 sccm, and more preferably 15 sccm.

The temperature of the substrate 120 having the first plasma polymer layer inside the plasma reaction chamber 110 is preferably room temperature, and the pressure inside the plasma reaction chamber 110 may be 10 mTorr to several torr, and preferably 30 mTorr.

In the preferred embodiment, the present invention relates to a method of manufacturing a patterned substrate for culturing cells, further comprising the step of forming a first patterned plasma polymer layer by re-integrating the first precursor material using a plasma between steps (3) and (4).

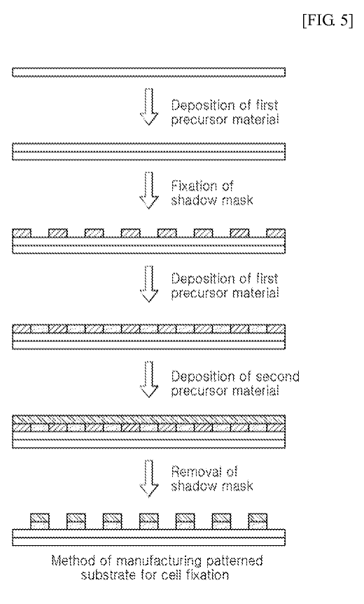

FIG. 5 is a schematic diagram showing another method of manufacturing a patterned substrate for culturing cells according to the present invention. With reference to FIG. 5, the above steps will be described in detail.

The method of manufacturing a patterned substrate for culturing cells described in FIG. 5 is different from the method described in FIG. 3 in that the first precursor material is deposited on the first plasma polymer layer in a patterned shape again, and the second plasma polymer layer is deposited thereon.

This manner can be employed, when the precise patterning is required in the method of manufacturing a patterned substrate for culturing cells. It is because that even though the first plasma polymer layer is formed using the identical first precursor material, adhesion degree of the second plasma polymer layer varies depending on the voltage supply condition.

For example, the second plasma polymer layer is deposited well on the first plasma polymer layer formed by supplying a voltage of 10 W to the internal electrode (SB), compared to the first plasma polymer layer formed by supplying a voltage of 70 W to the internal electrode (SB).

Meanwhile, an increase in S/N ratio can be achieved by this manner.

In another embodiment, the present invention relates to a patterned substrate for culturing cells, manufactured by the above described method of manufacturing a patterned substrate for culturing cells.

FIG. 4(b) is a plane view of the patterned substrate for culturing cells according to the present invention.

With reference to FIG. 4(b), the patterned substrate for culturing cells has convex portions having a diameter of 200 μm, and the space between the convex portions is 200 μm. In this connection, the first plasma polymer layer is formed on the substrate, and the second plasma polymer layer is formed on the first plasma polymer layer in a convex shape. That is, a substrate for culturing cells manufactured, in which the second plasma polymer layer is patterned in a predetermined shape.

In still another embodiment, the present invention is related to a patterning method for culturing cells, comprising the steps of preparing a patterned substrate for culturing cells by the above described method of manufacturing a patterned substrate for culturing cells; and culturing cells on the patterned substrate for culturing cells.

As used herein, the term “cell” refers to the fundamental structural and functional unit of all living organisms, and the cell type is not particularly limited. For example, cells isolated or activated from the liver, kidney, spleen, bone, bone marrow, thymus, heart, muscle, lung, brain, testis, ovary, islet, intestinal, ear, skin, gall bladder, prostate, bladder, embryos, immune system, and hematopoietic system may be used. Preferably, the cell is selected from the group consisting of microorganisms, cells and organs of animal/plant, neural cells, and endothelial cells.

Further, the method of culturing the above described cells on the second plasma polymer layer is not particularly limited, and is well-known. Therefore, a description of the method will be omitted.

In still another embodiment, the present invention relates to a cell chip, in which cells are cultured on the patterned substrate for culturing cells manufactured by the above described method of manufacturing a patterned substrate for culturing cells.

As used herein, the term “cell chip” means a biochip capable of detecting multiple physiological signals through cell responses, which cannot be detected by the conventional methods.

Preferably, the cell type is not particularly limited. For example, cells isolated or activated from the liver, kidney, spleen, bone, bone marrow, thymus, heart, muscle, lung, brain, testis, ovary, islet, intestinal, bone marrow, ear, skin, gall bladder, prostate, bladder, embryos, immune system, and hematopoietic system can be used. Preferably, the cell is selected from the group consisting of microorganisms, cells and organs of animal/plant, neural cells, and endothelial cells.

Hereinafter, the preferred Examples are provided for better understanding. However, these Examples are for illustrative purposes only, and the invention is not intended to be limited by these Examples.

### Preparation Example 1

### Formation of First Plasma Polymer Layer on Substrate

A plasma polymerized hexamethyldisiloxane (PPHMDSO) thin film prepared by plasma enhanced chemical vapor deposition using hexamethyldisiloxane as a first precursor material was deposited on a glass slide having a size of 75 mm×25 mm (Corning Microslide Plain, Cat#: 2947, Corning, N.Y.).

Specifically, the deposition was performed using the plasma enhanced chemical vapor deposition apparatus depicted in FIG. 1. The plasma reaction chamber 50 has a cylindrical shape and is constructed of stainless material. Hexamethyldisiloxane monomer was placed into the bubbler 30, 31 which was heated at 50° C. Hexamethyldisiloxane molecule was vaporized by using an inert gas of argon as a carrier gas and injected into the plasma reaction chamber 50. SB power was supplied to attach the rf generator to a slide substrate holder 51 to generate plasma around the slide. Here, the wall surface of the plasma reaction chamber 50 was put to earth. Meanwhile, the glass slide was washed with ultrasonic waves with trichloroethylene, acetone and methanol in that order, before it was placed in the plasma reaction chamber 50. The pressure of the plasma reaction chamber 50 was adjusted to about several mtorr using the vacuum pump 70. During the deposition, the substrate was maintained at room temperature and the flow rate of argon was maintained at 15 sccm. At this time, the deposition pressure of the plasma reaction chamber 50 was maintained at 500 mTorr, the internal electrode (SB) of the plasma reaction chamber 50 was maintained at 10 W, and the deposition was performed for 5 min. In this manner, a substrate having a first plasma polymer layer, in which a plasma polymerized hexamethyldisiloxane thin film was deposited on a glass slide, was manufactured.

### Preparation Example 2

### Formation of First Plasma Polymer Layer on Substrate

A substrate having a first plasma polymer layer, in which a plasma polymerized hexamethyldisiloxane thin film was deposited on a glass slide, was manufactured in the same manner as in Preparation Example 1, except that the internal electrode (SB) of the plasma reaction chamber 50 was maintained at 30 W in Preparation Example 2.

### Preparation Example 3

### Formation of First Plasma Polymer Layer on Substrate

A substrate having a first plasma polymer layer, in which a plasma polymerized hexamethyldisiloxane thin film was deposited on a glass slide, was manufactured in the same manner as in Preparation Example 1, except that the internal electrode (SB) of the plasma reaction chamber 50 was maintained at 50 W in Preparation Example 3.

### Preparation Example 4

### Formation of First Plasma Polymer Layer on Substrate

A substrate having a first plasma polymer layer, in which a plasma polymerized hexamethyldisiloxane thin film was deposited on a glass slide, was manufactured in the same manner as in Preparation Example 1, except that the internal electrode (SB) of the plasma reaction chamber 50 was maintained at 100 W in Preparation Example 4.

### Experimental Example 1

Rat intestinal epithelial cell-18 (IEC-18) was used to perform the experiment in order to examine whether the substrates having a first plasma polymer layer manufactured in Preparation Examples 1, 2, 3 and 4 are able to inhibit cell adsorption.

Rat intestinal epithelial cells were cultured on the substrates having a first plasma polymer layer manufactured in Preparation Examples 1, 2, 3 and 4 so as to examine whether the adsorption of intestinal epithelial cells is inhibited on the substrates. A culture medium was prepared by adding FBS (Fetal Bovine Serum) into DMEM (Dulbecco's modified Eagle's medium) including 4500 mg/l of high glucose to a concentration of 20%, and supplemented with penicillin/streptomycin and insulin. The external condition while the cells were cultured on the substrate was 37° C., 5% CO₂ environment (in a cell incubator).

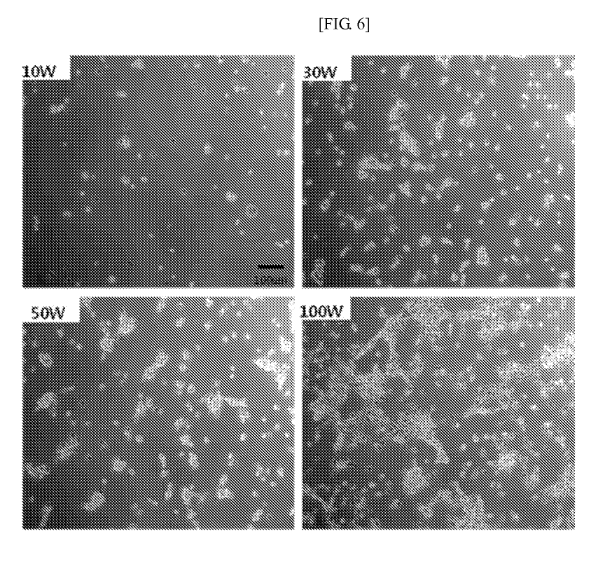

FIG. 6 shows photographs of rat intestinal epithelial cells, which were cultured for 24 hrs on the substrates having a first plasma polymer layer manufactured in Preparation Examples 1, 2, 3 and 4, and it can be seen that the substrate having a first plasma polymer layer manufactured in Preparation Example 1 shows the most effective inhibitory effect on cell adsorption.

### Preparation Example 5

### Formation of Second Patterned Plasma Polymer Layer on First Plasma Polymer Layer

Ethylenediamine was used as a second precursor material having a functional group. A plasma polymerized ethylenediamine (PPEDA) thin film prepared by the inductively coupled plasma enhanced chemical vapor deposition was deposited by patterning using a shadow mask with a predetermined pattern on a glass slide having a size of 75 mm×25 mm (Corning Microslide Plain, Cat#: 2947, Corning, N.Y.), on which the plasma polymerized hexamethyldisiloxane thin film was deposited.

Specifically, the deposition was performed using an inductively coupled plasma enhanced chemical vapor deposition apparatus depicted in FIG. 2. The plasma reaction chamber 110 has a cylindrical shape and is constructed of stainless material. The ethylenediamine precursor was placed into the bubbler 114 which was heated to 50° C. Ethylenediamine molecules were vaporized by using an inert gas of argon as a carrier gas and injected into the plasma reaction chamber 110. The inductively coupled plasma was generated around a shower ring 118 through an rf generator 116 where a circular coil was coupled. SB power was supplied to attach the rf generator to a slide substrate holder to generate plasma around the slide. Here, the wall surface of the plasma reaction chamber 110 was put to earth. The substrate used upon deposition of plasma polymerized ethylenediamine thin film was the substrate having the first plasma polymer layer manufactured in Preparation Example 1.

As shown in FIG. 4(a), a shadow mask having a predetermined pattern was placed on the substrate having the first plasma polymer layer manufactured in Preparation Example 1. Here, the predetermined pattern of the shadow mask was provided with a plurality of holes having a diameter of 200 μm, and the space between the holes was 200 μm. Subsequently, ethylenediamine was deposited on the exposed regions. The pressure of the plasma reaction chamber 110 was adjusted to about 10⁻⁵ torr by using the vacuum pump 112. During the deposition, the temperature of the substrate was maintained at room temperature and a flow rate of argon was maintained at 15 sccm. At this time, the deposition pressure of the plasma reaction chamber 110 were maintained at 30 mTorr, and the external electrode (ICP) and internal electrode (SB) of the plasma reaction chamber 110 was maintained at 3 W and 3 W, respectively. The deposition was performed for 2 min. In this manner, a patterned substrate for culturing cells, in which the second plasma polymer layer was patterned and deposited on the first plasma polymer layer, was manufactured.

### Experimental Example 2

Rat intestinal epithelial cell was used to perform the experiment in order to examine the selective cell culturing ability of the patterned substrate for culturing cells, which was manufactured in Preparation Example 5.

Rat intestinal epithelial cell was cultured on the patterned substrate for culturing cells, which was manufactured in Preparation Example 5, and the time-dependent, selective cell culture degree was examined. At this time, the experiment was performed in the same manner as in Experimental Example 1, except that the patterned substrate for culturing cells manufactured in Preparation Example 5 was used, and the culture degree was measured according to time.

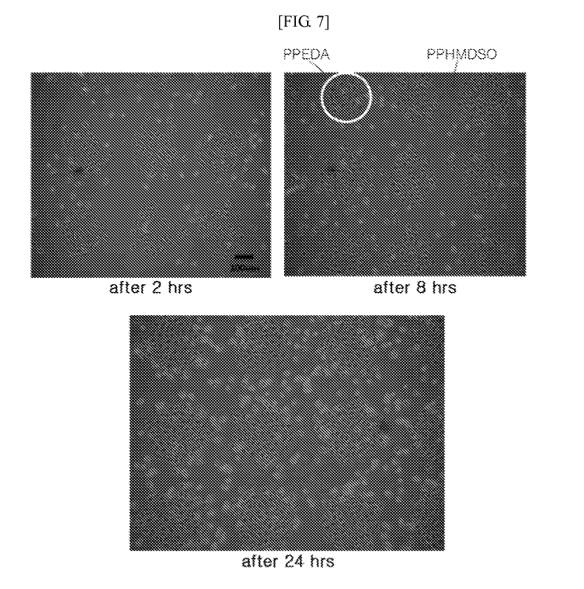

FIG. 7 shows photographs of rat intestinal epithelial cells, which were cultured for 2 hrs, 8 hrs, and 24 hrs on the patterned substrate for culturing cells manufactured in Preparation Example 5, and the selective cell adsorption can be examined according to time. It was found that the inhibitory effect on cell adsorption was observed in the plasma polymerized hexamethyldisiloxane thin film-deposited region, and the cell culture was observed in the plasma polymerized ethylenediamine thin film-deposited region. Meanwhile, the cells cultured in the PPEDA-deposited region were found to grow normally as time passes.

While the present invention has been described with reference to particular embodiments, it is to be appreciated that various changes and modifications may be made by those skilled in the art without departing from the spirit and scope of the present invention, as defined by the appended claims and their equivalents.

### EFFECTS OF THE INVENTION

According to the present invention, a surface capable of inhibiting cell adsorption and a surface capable of effectively culturing cells can be selectively patterned on a substrate.

Further, according to the present invention, cells can be selectively cultured only in a predetermined area by the above patterning method, and their intrinsic properties can be also maintained.

Further, according to the present invention, a small amount of cells can be selectively cultured in a desired position, and thus a cell chip can be mass-produced, leading to cost reduction in manufacture and production.

Further, according to the present invention, the cell chip is applicable in the development of artificial organs, implantable chips, and novel drugs, genomics, and proteomics.

Further, according to the present invention, a large volume of cells can be cultured using a small amount of cells, and thus rapid experiments relating to various cells can be achieved, which may be suitable for diagnoses of various diseases and profile construction for disorders in special groups.

Further, according to the present invention, the substrate allows uniform fixation of functional groups on a broad surface of the substrate within a short period of time, so that it is possible not only for mass production but also for commercialization.

What is claimed is:

1. A method of manufacturing a patterned substrate for culturing cells, comprising the steps of:
(1) preparing a substrate;
(2) forming a first plasma polymer layer by integrating a first precursor material using a plasma on the substrate;
(3) placing a shadow mask having a predetermined pattern on the first plasma polymer layer; and
(4) forming a second patterned plasma polymer layer by integrating a second precursor material using a plasma.

2. The method according to claim 1, further comprising the step of forming the first patterned plasma polymer layer by integrating the first precursor material using a plasma between steps (3) and (4).

3. The method according to claim 1, wherein the substrate is selected from the group consisting of glass, plastic, metal and silicone.

4. The method according to claim 1, wherein the first precursor material is selected from the group consisting of styrene and n-hexane.

5. The method according to claim 1, wherein the first precursor material is selected from the group consisting of siloxane-based compounds, including hexamethyldisiloxane, octamethyltrisiloxane, decamethyltetrasiloxane, hexa methylcyclotrisiloxane, octamethyl cyclotetrasiloxane, and decamethylcyclopentasiloxane.

6. The method according to claim 5, wherein the first precursor material is a siloxane-based compound, and the siloxane-based compound is hexamethyldisiloxane.

7. The method according to claim 1, wherein the second precursor material is selected from the group consisting of ethylenediamine, acetonitrile, allylamine, propylamine, cycloheptane, cyclohexane, and cyclopentane.

8. The method according to claim 1, wherein the first plasma polymer layer is formed by plasma enhanced chemical vapor deposition in step (2), and the second plasma polymer layer is formed by inductively coupled plasma enhanced chemical vapor deposition in step (4).

9. The method according to claim 1, wherein the first precursor material and the second precursor material are vaporized at the temperature of 30° C. to 70° C., and plasma-deposited.

10. The method according to claim 1, wherein the predetermined pattern of the shadow mask is provided with a plurality of holes having a diameter of 200 μm, and a space between the holes is 200 μm.

11. A patterned substrate for culturing cells, which is manufactured by the method of claim 1.

12. A patterning method for culturing cells, comprising the steps of:
preparing a substrate for culturing cells which is patterned by the method of claim 1; and
culturing cells on the patterned substrate for culturing cells.

13. The method according to claim 12, wherein the cell is selected from the group consisting of microorganisms, cells and organs of animal/plant, neural cells, and endothelial cells.

14. A patterned cell chip, wherein cells are cultured on the patterned substrate for culturing cells manufactured by the method of any one of claim 1.

15. The patterned cell chip according to claim 14, wherein the cell is selected from the group consisting of microorganisms, cells and organs of animal/plant, neural cells, and endothelial cells.
